(19) United States
(12) Patent Application Publication
(10) Pub. No.: US 2019/0117334 A1
(43) Pub. Date: Apr. 25, 2019

(54) ROOT CANAL FILLING INSTRUMENT

(71) Applicant: William L. Wildey, Hurst, TX (US)

(72) Inventor: William L. Wildey, Hurst, TX (US)

(21) Appl. No.: 15/792,986

(22) Filed: Oct. 25, 2017

(51) Int. Cl. A61C 5/40

(52) U.S. Cl. CPC A61C 5/40

(57) ABSTRACT

A root canal filling instrument is disclosed. The root canal filling instrument includes a shaft configured to be coupled to a dental hand piece and includes a material spreader. The material spreader includes a spindle coupled to and extending from the shaft and includes a spiral wire coupled to the shaft or the spindle and defining a columnar void, wherein the spindle extends into the columnar void.

### TECHNICAL FIELD

The embodiments relate to a dental instrument, and in particular to a root canal filling instrument.

### BACKGROUND

A root canal of a tooth often includes a number of lateral canals that are connected to a primary canal. When a dentist performs a root canal procedure, it is desirable to seal the lateral canals with a sealer material to prevent bacterial growth, and for other reasons.

Conventional devices used to urge the sealer material into the lateral canals include paper points and master cones. The use of such devices, however, increases the chance of root fracture, and thus must be manipulated very carefully and slowly, increasing the length of the procedure.

### SUMMARY

The embodiments relate to a root canal filling instrument that facilitates the spreading of material, such as sealer, into lateral canals of a root canal of a tooth.

In one embodiment, a root canal filling instrument is provided. The root canal filling instrument includes a shaft, which is configured to be coupled to a dental hand piece, and a material spreader. The material spreader includes a spindle, which is coupled to and extends from the shaft, and a spiral wire, which is coupled to the shaft or the spindle and which defines a columnar void, wherein the spindle extends into the columnar void.

In another embodiment, a method for filling a root canal of a tooth with a material is provided. The method includes inserting a root canal filling instrument into a root canal of a tooth. The root canal filling instrument includes a shaft, which is configured to be coupled to a dental hand piece, and a material spreader. The material spreader includes a spindle, which is coupled to and extends from the shaft, and a spiral wire, which is coupled to the shaft or the spindle and which forms a columnar void, wherein the spindle extends into the columnar void. The root canal filling instrument is caused to rotate to urge the material laterally into lateral canals of the root canal.

Those skilled in the art will appreciate the scope of the disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 illustrates a perspective view of a root canal filling instrument according to one embodiment;

FIG. 2 illustrates a perspective view of a root canal filling instrument, according to another embodiment;

FIG. 3 illustrates a perspective view of a root canal filling instrument, according to yet another embodiment;

FIG. 4 illustrates a root canal filling instrument in conjunction with a dental hand piece;

FIG. 5 illustrates the root canal filling instrument immediately prior to insertion into a tooth, according to one embodiment;

FIG. 6 illustrates the root canal filling instrument urging material into lateral canals of a root canal of a tooth, according to one embodiment; and

FIG. 7 is a flowchart of a method for filling a root canal of a tooth with a material, according to one embodiment.

### DETAILED DESCRIPTION

The embodiments set forth below represent the information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the embodiments are not limited to any particular sequence of steps. The term “about” used herein in conjunction with a numeric value means any value that is within a range of ten percent greater than or ten percent less than the numeric value.

As used herein and in the claims, the articles “a” and “an” in reference to an element refers to “one or more” of the element unless otherwise explicitly specified.

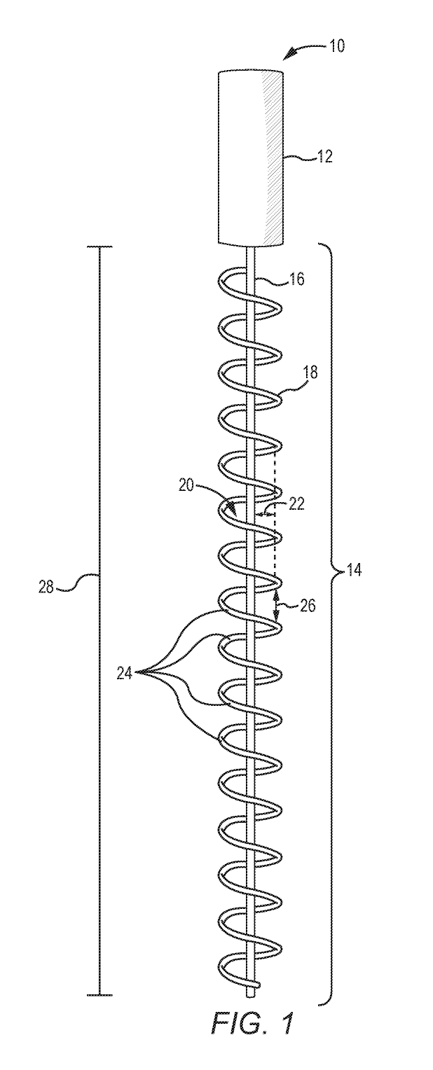

FIG. 1 illustrates a perspective view of a root canal filling instrument 10 according to one embodiment. The root canal filling instrument 10 includes a shaft 12 that is configured to be coupled to a dental hand piece (not illustrated). The root canal filling instrument 10 also includes a material spreader 14. The material spreader 14 includes a spindle 16 coupled to and extending from the shaft 12. The material spreader 14 also includes a spiral wire 18 coupled to the spindle 16. The spiral wire 18 defines a columnar void 20. The spindle 16 extends into the columnar void 20. In some embodiments, the spindle 16 extends an entire length of the columnar void 20, and extends beyond a length of the spiral wire 18.

In some embodiments, a distance 22 in a range between about 0.0 mm to about 5 mm may separate an exterior surface of the spindle 16 from an interior surface of the spiral wire 18 in a direction perpendicular to the length of the spindle 16. The spindle 16 may have a diameter in a range between about 0.01 mm to about 5 mm. The spiral wire 18 may have a diameter in a range between about 0.1 mm to about 5 mm. The spiral wire 18 comprises a plurality of loops 24, and a distance 26 between the loops 24 may be in a range between about 0.0 mm to about 25 mm.

In some embodiments, the material spreader 14 may comprise stainless steel, nickel titanium, titanium, carbon steel, plastics, carbon fiber, or composites. The material spreader 14 may have a length 28 in a range between about 1 mm to about 50 mm.

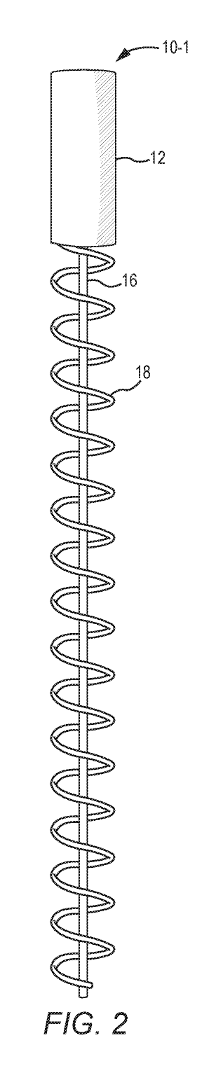

FIG. 2 illustrates a perspective view of a root canal filling instrument 10-1 according to another embodiment. The root canal filling instrument 10-1 is substantially similar to the root canal filling instrument 10 illustrated in FIG. 1, except the spiral wire 18 is coupled to the shaft 12 rather than the spindle 16.

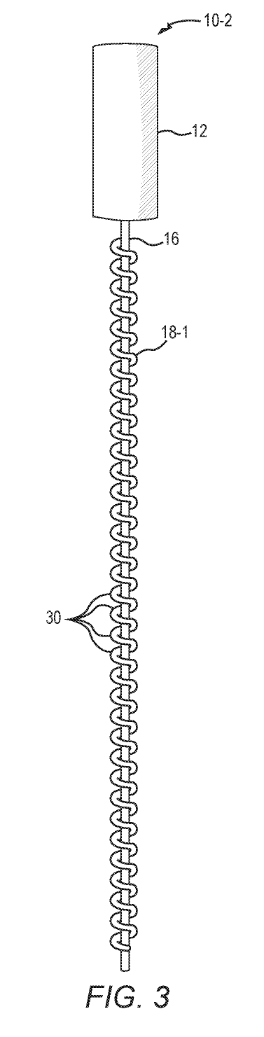

FIG. 3 illustrates a perspective view of a root canal filling instrument 10-2 according to yet another embodiment. In this embodiment, a spiral wire 18-1 defines a narrower columnar void than those illustrated in FIGS. 1 and 2, and thus the distance between the exterior surface of the spindle 16 and an interior surface of the spiral wire 18-1 is less than the distance 22 (FIG. 1) between the exterior surface of the spindle 16 and the interior surface of the spiral wire 18 illustrated in FIG. 1. The spiral wire 18-1 is also more tightly wound than the spiral wire 18, and thus loops 30 of the spiral wire 18-1 are closer to one another than the loops 24 (FIG. 1) of the spiral wire 18.

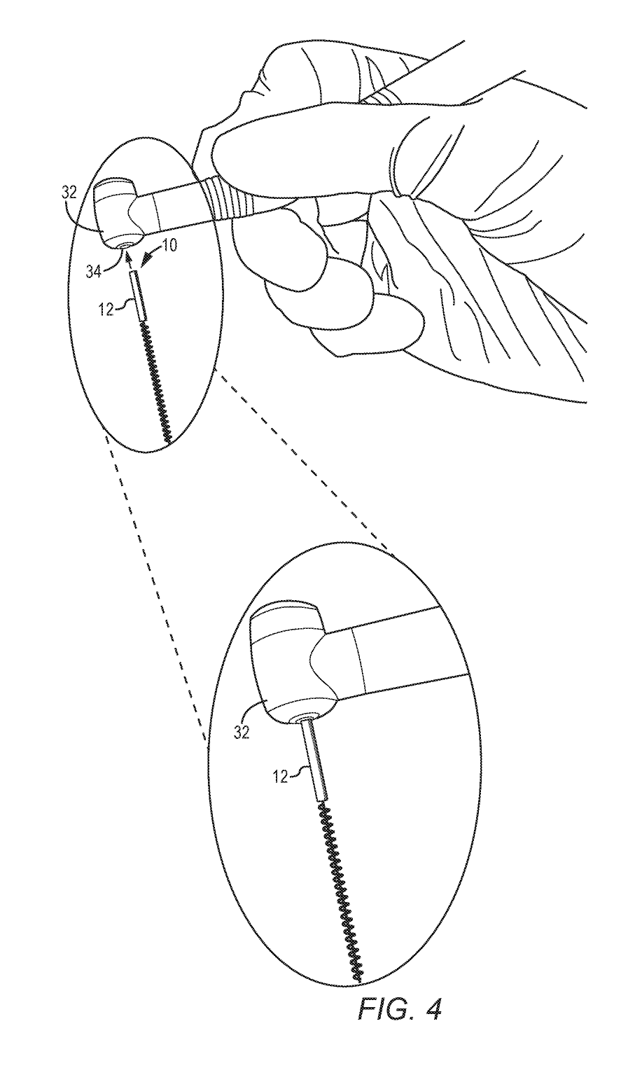

FIG. 4 illustrates the root canal filling instrument 10 in conjunction with dental hand piece 32. The dental hand piece 32 includes a chuck 34 into which the shaft 12 of the root canal filling instrument 10 is inserted and configured to fit.

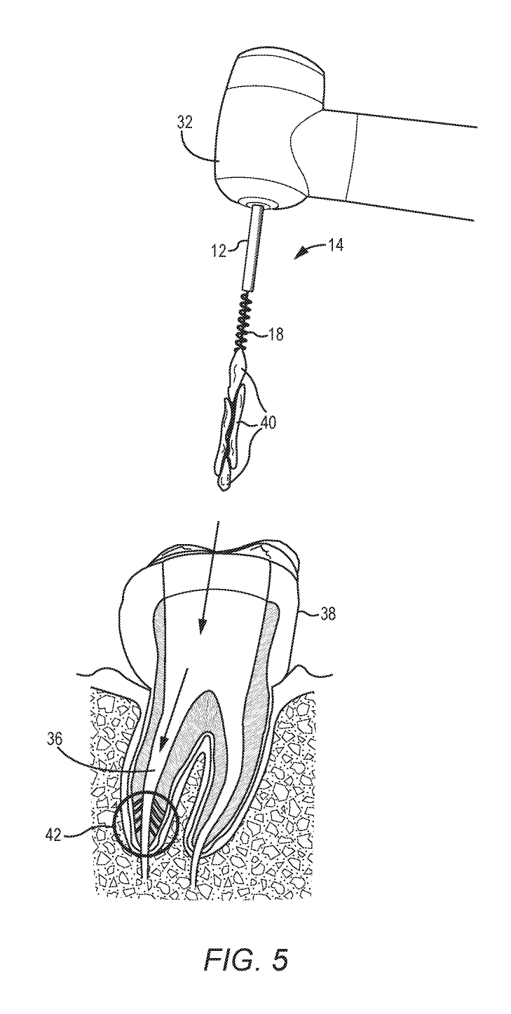

FIG. 5 illustrates the root canal filling instrument 10 immediately prior to insertion into a root canal 36 of a tooth 38. In one embodiment, material 40, such as a sealer material, may be placed on to the spiral wire 18 prior to insertion into the tooth 38. In other embodiments, the material 40 may be inserted into the root canal 36 prior to insertion of the material spreader 14 into the tooth 38. Note that the root canal 36 includes a primary channel and a plurality of lateral canals 42.

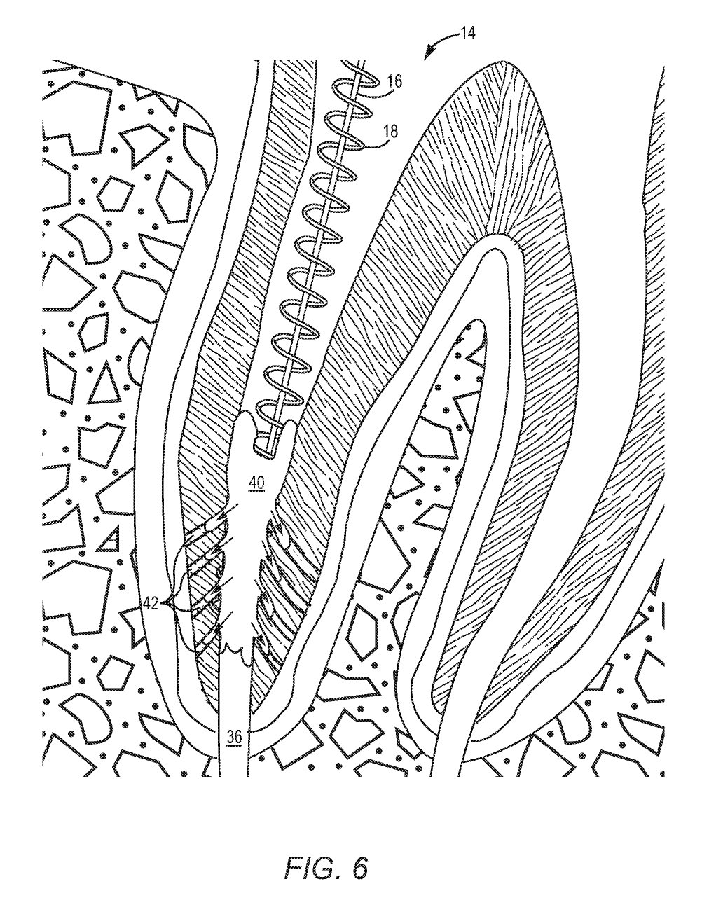

FIG. 6 illustrates the root canal filling instrument 10 urging the material 40 into the lateral canals 42, according to one embodiment. As the dental hand piece 32 (FIG. 5) rotates the material spreader 14, the spiral wire 18 also rotates, urging the material 40 into the lateral canals 42. Unlike conventional mechanisms, there is no need to apply lateral pressure to the walls of the primary channel of the root canal 36 to urge the material 40 into the lateral canals 42, which increases the chance of root fracture.

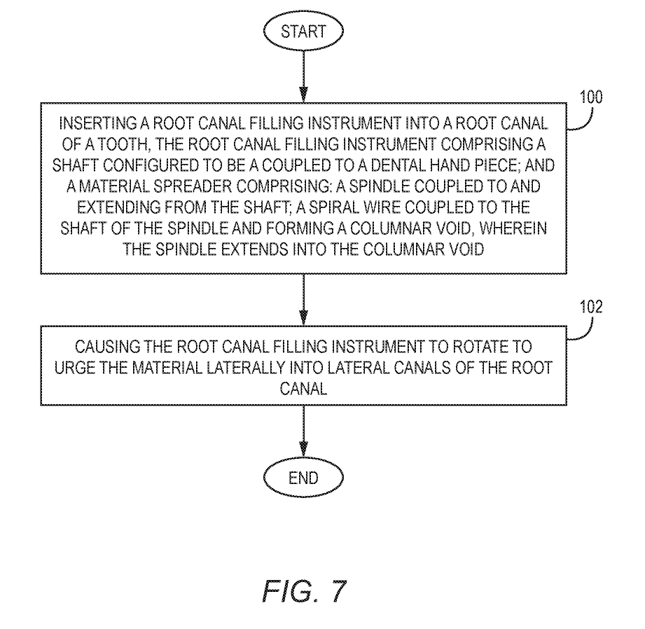

FIG. 7 is a flowchart of a method for filling a root canal of a tooth with a material according to one embodiment. The root canal filling instrument 10 is inserted into the root canal 36 of the tooth 38. The root canal filling instrument 10 includes the shaft 12, which is configured to be coupled to the dental hand piece 32, and the material spreader 14. The material spreader 14 includes the spindle 16, which is coupled to and extends from the shaft 12, and the spiral wire 18, which is coupled to the shaft 12 or to the spindle 16 and which forms a columnar void 20, wherein the spindle 16 extends into the columnar void 20 (FIG. 7, block 100). The root canal filling instrument 10 is caused to rotate to urge the material 40 laterally into the lateral canals 42 of the root canal 36 (FIG. 7, block 102).

Those skilled in the art will recognize improvements and modifications to the preferred embodiments of the disclosure. All such improvements and modifications are considered within the scope of the concepts disclosed herein and the claims that follow.

1. A root canal filling instrument comprising:
a shaft configured to be coupled to a dental hand piece; and
a material spreader configured to urge a material laterally into lateral canals of a root canal comprising:
a spindle coupled to and extending from the shaft; and
a spiral wire coupled to the shaft or the spindle and defining a columnar void, wherein the spindle extends into the columnar void, wherein the spiral wire extends from a first end portion of the spindle to a second end portion of the spindle and wherein an interior surface of the spiral wire contacts the spindle the entire distance from the first end portion of the spindle to the second end portion of the spindle such that there is no gap between the interior surface of the spiral wire and the spindle.

2. The root canal filling instrument of claim 1 wherein a distance between an exterior surface of the spindle and the interior surface of the spiral wire is in a range between about 0.0 mm to about 5 mm.

3. The root canal filling instrument of claim 1 wherein the spiral wire comprises a plurality of loops, and a distance between successive loops is in a range between about 0.0 mm to about 25 mm.

4. The root canal filling instrument of claim 1 wherein the material spreader comprises stainless steel, nickel titanium, titanium, carbon steel, plastics, carbon fiber, or composites.

5. The root canal filling instrument of claim 1 wherein the spindle extends an entire length of the columnar void.

6. The root canal filling instrument of claim 1 wherein the spindle extends beyond the columnar void.

7. The root canal filling instrument of claim 1 wherein the spindle has a diameter in a range between about 0.01 mm to about 5 mm.

8. The root canal filling instrument of claim 1 wherein the spiral wire has a diameter in a range between about 0.1 mm to about 5 mm.

9. The root canal filling instrument of claim 1 wherein the spindle has a greater diameter than the spiral wire.

10. The root canal filling instrument of claim 1 wherein the material spreader has a length in a range between about 1 mm to about 50 mm.

11. A method for filling a root canal of a tooth with a material, comprising:
inserting a root canal filling instrument into a root canal of a tooth, the root canal filling instrument comprising:
a shaft configured to be coupled to a dental hand piece; and
a material spreader comprising:
a spindle coupled to and extending from the shaft; and
a spiral wire coupled to the shaft or the spindle and forming a columnar void, wherein the spindle extends into the columnar void, wherein the spiral wire extends from a first end portion of the spindle to a second end portion of the spindle and wherein an interior surface of the spiral wire contacts the spindle the entire distance from the first end portion of the spindle to the second end portion of the spindle such that there is no gap between the interior surface of the spiral wire and the spindle; and
causing the root canal filling instrument to rotate to urge the material laterally into lateral canals of the root canal.

12. The method of claim 11 further comprising:
placing the material on the material spreader prior to inserting the root canal filling instrument into the root canal of the tooth.

13. The method of claim 11 further comprising:
placing the material in the root canal prior to inserting the root canal filling instrument into the root canal of the tooth.

14. The root canal filling instrument of claim 1 wherein the material spreader comprises only one spiral wire.
